(19) United States
(12) Patent Application Publication
(10) Pub. No.: US 2006/0196431 A1
(43) Pub. Date: Sep. 7, 2006

(54) Method and apparatus for providing at least one item of information on occupancy of a milking stall in a milking facility

(76) Inventors: Peter Kaever, Oelde (DE); Manfred Pohlkamp, Oelde (DE)

Correspondence Address: SMITH LAW OFFICE, 440 SCIENCE DR., SUITE 302, MADISON, WI, 53711, US

(21) Appl. No.: 11/367,945

(22) Filed: Mar. 3, 2006

(30) Foreign Application Priority Data
Mar. 3, 2005 (DE) 10 2005 009 741.3

(51) Int. Cl. A01J 5/00

(52) U.S. Cl. 119/14.04

(57) ABSTRACT

A method is proposed for providing at least one item of information on occupancy of a milking stall in a milking facility having at least two milking stalls, which are arranged on a movable platform, in accordance with which method a movement of an animal out of an identification area in the direction of a milking stall is detected.

The subject matter of the invention relates to a method for providing at least one item of information on occupancy of a milking stall, to an apparatus for providing at least one item of information on occupancy of a milking stall and to a milking facility having at least two milking stalls.

Although the invention will be described below with reference to the use in carousel milking facilities, reference is made to the fact that the subject matter of the invention can also be used with other movable transport devices. The method according to the invention can also be used in other milking facilities, for example in milking facilities in which the animals to be milked are positioned on a conveyor belt in order to be able to move these animals from an entrance to the exit, for example during a milking operation. The method according to the invention is also suitable for automated tandem milking parlours.

The invention is not only suitable for use in milking facilities for milking cows, but also for milking other milk-producing animals, such as goats, sheep, mares, donkeys, camels, dromedaries, yaks, elks or the like.

Carousel milking facilities are known for milking animals, in particular for milking cows. Such carousel milking facilities may have various designs. For example, DE 26 50 741 A1 has disclosed a carousel milking facility having a plurality of milking stalls. The milking stalls are arranged side by side. This milking facility is a so-called side by side carousel milking facility. The animals are guided radially inwards towards the milking stalls. For this purpose, a gate is drawn upwards which makes it possible for the animals to enter the milking stall. Once the cow has entered the milking stall, the gate is lowered again. The platform is moved on with the individual milking stalls.

A further design for a carousel milking facility is known, for example, from DE 41 01 530 A1. The carousel milking facility described therein has a platform, which is arranged such that it can rotate and on which a plurality of milking stalls are formed. The platform has a segmented design. It is driven, for example, by a plurality of hydraulic motors and a hydraulic pump driven by an electric motor.

In the course of automating milking and of monitoring the animals, in particular as regards their health and milk output, it is known for the animals to be provided with an animal identification unit. The animal identification unit may contain a memory, which contains a large number of items of information on the animal.

In order to be able to assign the data obtained during a milking operation to an animal in a reliable manner, it is necessary to have knowledge of which stall is occupied by that animal. Position identification can be implemented, for example, by stall responders. The stall responders are arranged at the individual milking stalls in the facility. A passing antenna orders the stall responders as it passes by. The responder code for the stall is transmitted to a computer and is assigned to the respective stall.

With regard to the fact that the resolution of the stall identification is relatively low, additional sensors have been incorporated for the purpose of detecting certain critical points, in which case the sensors used may be, for example, light sensors.

Such an arrangement of sensors at critical points is known from EP-A1-0 717 590. These sensors form part of a control and drive device for a carousel milking facility. In accordance with EP-A1-0 717 590, a first checkpoint is provided for the purpose of monitoring the milking position. When viewed in the direction of rotation, a second checkpoint is arranged after the first checkpoint. The rotational speed of the platform is set by means of the control and drive device such that the majority of the milking equipment is not yet removed at the first checkpoint and the majority of the milking equipment is removed at the second checkpoint.

In order to be able to assign an animal to a milking stall in a carousel milking facility, an entrance door is provided on the access path to the carousel milking facility. In front of this entrance door, the animal is identified. Once the animal has been identified and the milking stall provided for this animal has been identified, the door opens, if the milking stall is in front of the access point, such that the animal can enter this milking stall. The door closes the access such that the next animal is halted.

One problem with such a method is the fact that each individual animal needs to be halted in front of the door in order to make reliable assignment of the milking stall and the animal milked at this milking stall possible. This results in a reduced throughput per unit time and thus in longer milking times. The opening and closing of the door entails noise development and wear.

Carousel milking facilities have therefore been developed which have an access path without a door or whose door is brought out of operation during specific milking phases. In the case of such carousel milking facilities, the animal is identified on the access path. As a result, it is not possible to clearly establish whether an animal is actually even occupying the provided milking stall. There is therefore the risk, for example, of an animal being falsely assigned to a stall. As a result, milk from an animal which is not suitable for circulation and should actually be disposed of can nevertheless be passed to the milk suitable for circulation since the animal did not occupy the milking stall provided for this animal but occupied a different stall. This situation may lead to all of the useable milk needing to be disposed of.

WO 02/03783 has already disclosed a method which has been proposed for identifying a milking stall and an animal, in particular a cow, at the milking stall of a carousel milking facility having a plurality of arranged milking stalls, which are arranged on a milking platform which can rotate, in the case of which method an animal having an animal identification unit reaches a milking stall. The animal and the milking stall in which the animal is located are identified, in which case the identification data of the animal and the milking stall are passed on to a data processing system and are evaluated there. Specifically, it is proposed that the milking platform with the animal moves past a stationary unit for animal identification, which is downstream of the access path when viewed in the direction of rotation of the milking platform. As a result, clear assignment of an animal to a milking stall is achieved since the animal identification only takes place when the animal is already occupying the milking stall. In addition to the identification of the animal, identification of the milking stall also takes place by means of a unit for milking stall identification. With this method, there are a few stalls in the entrance region on which the animals have not yet been identified. This is disadvantageous for the functional ergonomics because the exit region should be close to the entrance.

Starting from this, the invention is based on the object of proposing a method for providing at least one item of information on occupancy of a milking stall in a milking facility having at least two milking stalls, by means of which method increased assignment reliability is achieved at an earlier point in time.

This object is achieved according to the invention by a method having the feature of claim 1. Advantageous developments and refinements of the method are the subject matter of the dependent claims.

The method according to the invention for providing at least one item of information on occupancy of a milking stall in a milking facility having at least two milking stalls, which are arranged on a movable platform, is characterized by the fact that a movement of an animal out of an identification area in the direction of a milking stall is detected. As a deviation from the previously known methods for determining occupancy of a milking stall, the assignment is controlled on the basis of the movement of an animal and not on the basis of the movement or the position of the platform. Owing to this concept according to the invention, sensors may be used for the purpose of detecting critical positions of an animal. On the basis of the signals from these sensors it is possible to connect the item of information “animal boards the platform” to the position of the platform such that it is possible to determine, with an increased degree of reliability, occupancy of a milking stall, i.e. assignment of the animal to a stall on the platform.

In particular, it is proposed that the time is detected at which an animal leaves an identification area in the direction of a milking stall. The time can be correlated with the movement of the platform such that, as a result, it is possible to determine the stall which is occupied by the animal.

Detection of the movement of an animal out of an identification area in the direction of a milking stall can take place by means of various position and/or movement sensors. A sensor is understood to mean both a sensor element and a complex system which is suitable for detecting the movement of an animal out of an identification area in the direction of a milking stall. In this case, a method is preferred in which the movement of an animal is detected optically, in particular by means of a camera system. The optical detection can also be implemented by means of simple light barriers.

In particular, it is proposed that detection of the movement of an animal out of an identification area in the direction of a milking stall takes place by means of an identification unit, said identification unit having at least one transmitter and at least one receiver. In this case, a design is preferred in which a transmitter is arranged on the animal which preferably also transmits animal-individual items of information. In this case, the use of tags (for example radiofrequency labels) fitted to individual animals is one option which is particularly suitable for this purpose.

Owing to the method according to the invention, the relevant items of animal information are made available very early once an animal has boarded the platform in order to correctly carry out any animal-related actions on the animal. These animal-related actions can take place automatically. It is also possible for the animal-related actions which should be carried out to be displayed to an operator optically and/or acoustically. The animal-related actions may be, for example, treatment of an animal.

Further advantages of the method also result from the fact that a position of the platform and/or milking stalls is determined at the time at which an animal leaves an identification area in the direction of a milking stall. This makes it possible to achieve improved assignment of an animal to a milking stall. Furthermore, it is also possible to identify empty stalls. In particular in the case of undecided animals which do not move out of the identification area within a predetermined period of time, it is possible to drive the animal such that it boards the platform. When using the method proposed here, this leads to correct assignments since it is possible to identify whether the animal is moving.

The position of the platform is preferably determined by a position detection unit. In particular, it is proposed that the speed of the platform is determined. The speed of the platform can also be altered as a function of the occupancy situation at at least one milking stall. It is thus possible, for example, for the speed to be increased if a plurality of the milking stalls are occupied by animals which can be milked in a relatively short period of time. It may also be necessary to slow down the rotational movement of the platform if the milking times of the animals located on the platform indicate that this should happen.

The determination of the position of the platform takes place on the basis of data from at least one sensor, which is taken from a group of sensors which comprises angle sensors, angle coders, absolute angle coders, incremental angle coders, angle encoders, rotation sensors or the like.

In accordance with yet another advantageous refinement of the method, it is proposed that the data for determining the position are transmitted to a control device.

The method according to the invention makes it possible to improve the assignment of empty and occupied stalls such that these items of information can be incorporated in the planning of automatically running processes such as cleaning and/or treatment of animals and positioning of the milking cups in order to make efficient use of the available time per automation unit. Furthermore, it is possible to carry out a diagnosis in the system. It is possible, in particular by means of sensor-related redundancies, to check the functioning of the sensors and, in the event of erroneous functioning, to pass a message indicating erroneous functioning on to the operator.

The method according to the invention is particularly suitable for use in a carousel milking facility.

The present invention is also based on the object of specifying an apparatus for providing at least one item of information on occupancy of a milking stall in a milking facility having at least two milking stalls, which apparatus can be implemented with relatively little technical complexity.

This object is achieved according to the invention by an apparatus having the features of claim 16. Advantageous developments and refinements of the apparatus are the subject matter of the respective dependent claims.

The apparatus according to the invention for providing at least one item of information on occupancy of a milking stall in a milking facility having at least two milking stalls, which are arranged on a movable platform, has a device which is suitable for and geared towards detecting a movement of an animal out of an identification area in the direction of a milking stall. As a result, an apparatus is produced for providing at least one item of information which can be implemented with little design complexity. The identification area is in this case preferably arranged such that, when leaving the identification area, the animal enters a milking stall on the platform.

In accordance with one advantageous refinement of the apparatus, it is proposed that the device has means for determining a time at which an animal moves in the direction of the platform/milking stall. In this case, a refinement is preferred in which detection of events takes place, to be precise at the time at which the animal moves out of the identification area in the direction of a milking stall and the time at which a milking stall is made available to the animal. As a result, it is possible for clear assignment of the milking stall and the animal to take place, in which case the connecting element for the determination of the occupancy of a milking stall with an animal is the time.

The movement of an animal can be determined by means of a device which has at least one position and/or movement sensor. The position and/or movement sensors may have various designs. In this case, the position and/or movement sensors may be proximity sensors, optical sensors or the like. Complex sensor systems, in particular a camera system, are also possible.

The animals, in particular cows, are provided with identification means. These identification means contain animal-individual items of information. They may be in the form of transmitters or in the form of receivers and transmitters. The presence of such animal labels can be used for the purpose of determining the movement of the animal. In particular, it is therefore proposed that the device has at least one identification unit having at least one transmitter and at least one receiver. In this case, the evaluation of information on the field strength and the type of label as well as label-related characteristic values such as, for example, typical identification field strengths may also be useful. It is further proposed to incorporate the identification capability of the read device in the evaluation. This animal label is essentially read when it is located in the identification area. This identification area may depend on the orientation of the label, the label type and also the location. The identification area is spatially delimited such that an item of information can be derived as to when an animal left the identification area. If, in a first approach, for example, one assumes that animals move in the direction towards the platform, this item of information can be used to produce the assignment between the animal and the stall on the platform.

In addition to the identification units of the animals, additional sensors may be provided in the identification area which are also suitable for detecting the movement of the animal, with the result that the instant when the animal enters the stall on the platform is identified.

Since individual items of information are provided by the animal, it is also possible for the animal to be treated at an earlier point in time, as a result of which the efficiency of the milking facility can be increased. In particular as a result of the fact that animal-individual data are available at an earlier point in time, operating units of the milking facility can be activated in order to carry out operations involving the animal substantially shortly after the animal has entered the milking stall.

Efficiency can also be increased further by the fact that means are provided which can be used to determine a position of the platform and/or the milking stalls at the time at which an animal leaves an identification area in the direction of a milking stall.

In accordance with a further advantageous concept, it is proposed that the means comprise at least one position detection unit, which can be used to determine a position of the platform. The position detection unit has at least one sensor, which is taken from a group of sensors which comprises angle sensors, angle coders, absolute angle coders, incremental angle coders, angle encoders, rotation sensors or the like.

In accordance with a further inventive concept, a milking facility having at least two milking stalls, which are arranged on a movable platform, is proposed, in which case the milking facility contains an apparatus for providing at least one item of information on occupancy of a milking stall in accordance with one or more of claims 18 to 26 and an information processing device for the purpose of processing the at least one item of information. In particular, it is proposed that the information processing device interacts with a control device.

In order to increase the efficiency of the milking facility and in order to improve the herd management, it is proposed that the information processing device interacts with a herd management system.

The milking facility is preferably a carousel milking facility.

Further details and advantages of the invention will be explained with reference to the exemplary embodiment illustrated in the drawing without the subject matter being restricted to this exemplary embodiment.

In the drawing:

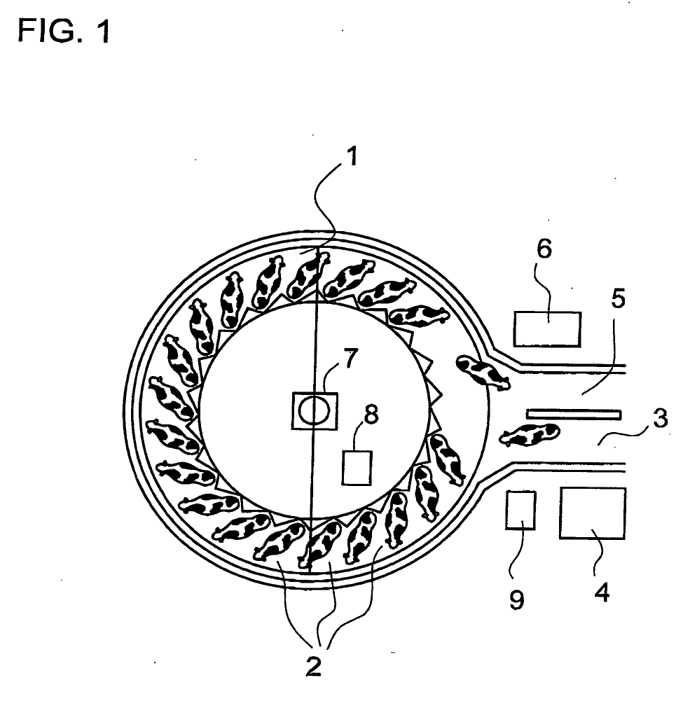

FIG. 1 shows a schematic plan view of a carousel milking facility,

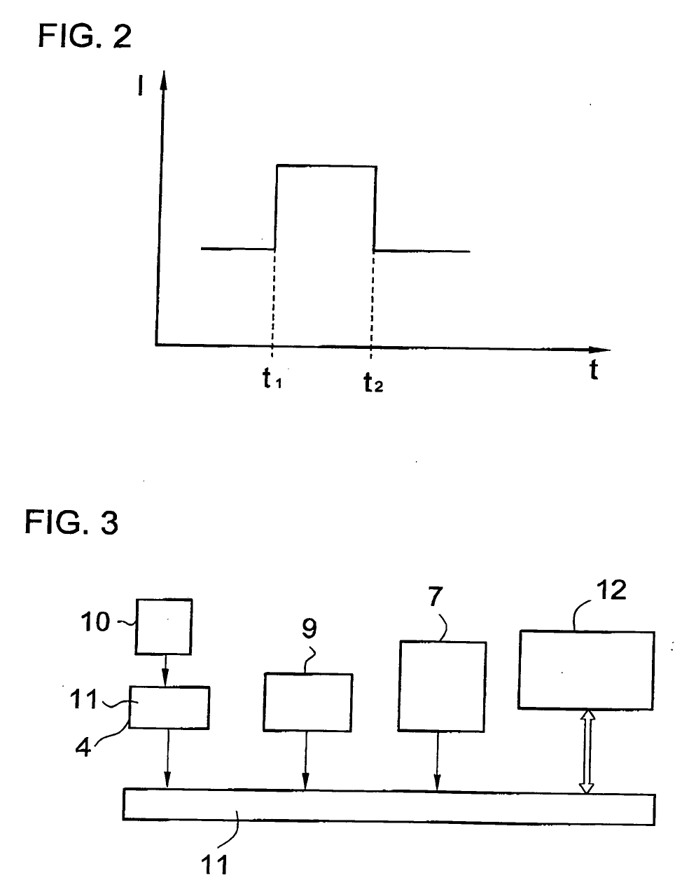

FIG. 2 shows a graph of a signal profile, and

FIG. 3 shows a block diagram of components in a system for assigning animals on a movable platform.

FIG. 1 shows a schematic illustration of a carousel milking facility. The carousel milking facility has an essentially annular platform 1. A plurality of milking stalls are formed on the platform 1. The milking stalls 2 are separated from one another such that in each case one animal can occupy a milking stall.

An access path 3 leads up to the platform 1 which can rotate. A device for animal identification 4 is provided on this access path 3, by means of which device it is possible to identify a cow if it approaches the carousel milking facility.

Each animal leaves the carousel milking facility via an exit 5. A monitoring device 6 is arranged in the exit 5 which can be used to establish whether an animal, in particular a cow, has left the carousel milking facility.

In the exemplary embodiment illustrated, a central position detection unit 7 is arranged in the centre of the carousel milking facility and can be rotated about an axis of rotation of the platform 1. The position detection unit 7 and the platform 1 are coupled to one another such that they are rotated synchronously with one another.

In order to operate the carousel milking facility, a control panel 8 is arranged in a central region, which can be entered by an operator. The control panel 8 may also contain display devices and instruments, from which it is possible to call up the present milking situation at individual milking stalls. Furthermore, the present status of the milking facility can be checked at the control panel 8.

A device 9 is provided for the purpose of providing at least one item of information on occupancy of a milking stall in the milking facility having the milking stalls 2, which are arranged on the movable platform 1. This device 9 is positioned in the region of the access 3. It is used for detecting a movement of an animal out of an identification area in the direction of a milking stall 2 on the platform 1. The assignment of an animal to a milking stall is thus dependent on the movement of the animal. The device may therefore have sensors which are positioned at critical positions in the milking facility. In particular, the device 9 with the sensors is arranged on the access path 3 such that the device generates an item of information which corresponds to the contents “animal boards the platform”. This achieves a high degree of assignment reliability between an animal and a stall of the platform.

The device may have various position and movement sensors for the animal, which, as the information source, produce items of information for the identification of the movement of an animal in the direction of a milking stall, and these items of information can also be further processed.

FIG. 2 illustrates a signal profile for a signal I. At time t₁, it is identified that an animal enters the identification area. Time t₂ provides the item of information indicating that the animal is leaving the identification area. The device is also designed such that it identifies the movement direction of the animal in order to avoid, in the event of a rearward movement of the animal, this movement being interpreted incorrectly.

If the time t₂ at which the animal boards the platform is known and the movement of the platform is likewise known, it is possible to precisely determine the milking stall on which the animal is positioned using this information. The position of the individual milking stalls at time t₂ takes place by means of the position detection unit 7. It is therefore possible to assign, at time t₂, a specific milking stall to the access path.

In order to achieve good circulation of the animals, it is advantageous if a maximum of two stalls are partially open at a specific point in time. With the aid of the information on the position and possibly on the speed of the platform 1, it is possible to comment on the assignment on an animal to a stall. In particular, the movement direction of the platform, the proportion of the time for which the two stalls located in front of the entrance area are open and the state of occupation of the platform can be taken into consideration.

A block diagram is illustrated schematically in FIG. 3. The animal which passes the access path has an animal label 10, which is identified by the device 4. The device 4 passes the items of information read from the animal label 10 to an assignment unit 11. The items of information obtained from the animal label 10 can be passed on to a herd management system 12, by means of which components of the milking facility are activated in order to carry out an action involving the animal.

The device 9 is used to determine the time at which an animal leaves the identification area and enters a milking stall on the platform. This item of information is transmitted to the assignment unit 11. Furthermore, the position detection unit 7 for the purpose of detecting the position of the platform or the milking stalls makes available items of information to the assignment unit such that these items of information are processed in the assignment unit 11, with the result that assignment of an animal to a specific milking stall is achieved.

The refinement of the method or the apparatus according to the invention also means that partially automated functions such as cleaning or treatment of the udders is assisted with the aid of corresponding automation devices. Precisely when automating or partially automating functions adjacent to the entrance area of the carousel, correct assignment of an animal to a milking stall at an early point in time makes it possible for the automation components to carry out the correct actions on the animal. If the assignment cannot be carried out until a later point in time, it is possible that an action cannot be carried out in a manner relating to the individual animal. Additional boundary conditions and uncertainties result during the assignment, in particular in the case of partially automated or completely automated operation, and these boundary conditions and uncertainties make operation more difficult. This is avoided by the invention.

The invention can be applied both to conventional and also to partially automated or semi-automated and completely automated or robot-assisted milking parlours. In particular, it can be applied to carousels which are designed as internal milkers or external milkers.

### LIST OF REFERENCES

1 Platform
2 Milking stall
3 Access path
4 Device
5 Exit
6 Monitoring device
7 Position detection unit
8 Control panel
9 Device
10 Label
11 Assignment unit
12 Herd management system

1. A method for providing at least one item of information on occupancy of a milking stall in a milking facility having at least two milking stalls, which are arranged on a movable platform, characterized by detection of a movement of an animal out of an identification area in the direction of a milking stall.

2. The method according to claim 1, characterized by detection of a time at which an animal leaves an identification area in the direction of a milking stall.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)
